(19) United States
(12) Patent Application Publication
(10) Pub. No.: US 2010/0309213 A1
(43) Pub. Date: Dec. 9, 2010

(54) Adaptive Stepping-Control System and Method for Dynamic Backlight Control

(75) Inventors: SHING-CHIA CHEN, TAINAN (TW); KUO-LIANG SHEN, TAINAN (TW)

Correspondence Address: STOUT, UXA, BUYAN & MULLINS LLP, 4 VENTURE, SUITE 300, IRVINE, CA, 92618, US

(73) Assignees: HIMAX MEDIA SOLUTIONS, INC., TAINAN (TW); HIMAX TECHNOLOGIES LIMITED, TAINAN (TW)

(21) Appl. No.: 12/480,631

(22) Filed: Jun. 8, 2009

(51) Int. Cl. G09G 5/10

(52) U.S. Cl. 345/589

(57) ABSTRACT

An adaptive stepping-control system and method for dynamic backlight control (DBLC) is disclosed. A stepping-control unit adjusts output of a dynamic backlight control (DBLC) device, such that the backlight luminance generated from a backlight unit may change smoothly. The amount of change of the backlight luminance per unit time (or stepping rate) varies according to the content of the image data.

### BACKGROUND OF THE INVENTION

1. Field of the Invention

The present invention generally relates to dynamic backlight control, and more particularly to an adaptive stepping-control system and method for the dynamic backlight control.

2. Description of Related Art

Backlighting is used to illuminate a flat panel display, such as a liquid crystal display (LCD), from the back or side of the flat panel display. The light source of a backlight may be a cold cathode fluorescent lamp (CCFL), light-emitting diode (LED) or other light source.

A constant backlight is a backlight that outputs even and constant light no matter how the image data or the ambient light has been changed. The constant backlight has a disadvantage, among others, that the display has light leakage caused by the backlight when the pixels of the display are in dark level (“0”), which results in low dynamic contrast.

In order to alleviate this disadvantage, a dynamic backlight (DBL) has been proposed to dynamically or adaptively adjust (overall or respective portions of) backlight luminance in accordance with image data distribution or the ambient light. For example, the backlight outputs high luminance when the image is bright and is dimmed to output low luminance when the image is dark, thereby reducing light leakage. Accordingly, the dynamic backlight has a higher dynamic contrast than the constant backlight. Further, the dynamic backlight reduces power consumption as compared to the constant backlight.

Nevertheless, for cases where the neighboring image frames have distinct brightness (for example, an image frame with 10% brightness followed by a succeeding image frame with 90% brightness), the backlight should not sharply change its output luminance; otherwise, the viewer will suffer an annoying flicker effect. In order to avoid such problem, the backlight should change its output luminance in a smooth manner. FIG. 1 is a graph corresponding to a conventional technique used to smoothly change the backlight luminance. In the exemplary figure, the backlight is supposed to change its luminance from an original luminance value (v) to a target luminance value (v+4) in a stepwise manner. As shown in the figure, instead of sharply or directly changing from the original value (v) to the target value (v+4), the backlight increases its luminance a little bit at a time. Specifically, the backlight increases with a unit luminance per unit time. In other words, the conventional mechanism depicted in FIG. 1 has a constant stepping rate (also known as dimming rate) of luminance change.

The conventional technique as described above works acceptably in some applications in which the neighboring image frames have similar brightness, such as for a the graphical user interface (GUI) displayed on a personal computer monitor. However, this conventional technique works poorly in other applications in which the neighboring image frames have distinct brightness, such as animations or motion pictures. In one scenario, while luminance of the backlight is increasing to a target luminance value according to the stepwise technique of FIG. 1, the display nevertheless may abruptly change (from the bright image frame) to a dark image frame, thus forcing the backlight to decrease its luminance before the target luminance has ever been reached.

For the reason that conventional backlight control cannot respond fast enough to image changes, a need has arisen to propose an efficient mechanism that is capable of adaptively controlling the stepping rate (or dimming rate) of the backlight luminance such that the backlight not only can respond fast enough but also can smoothly change its luminance.

### SUMMARY OF THE INVENTION

In view of the foregoing, it is an object of the present invention to provide an adaptive stepping control for a dynamic backlight, for the purposes of achieving smoothness of display and satisfactory dynamic contrast.

According to one embodiment, a stepping-control unit adjusts the output of a dynamic backlight control (DBLC) device, such that the backlight luminance generated from a backlight unit may change smoothly. The amount of change of the backlight luminance per unit time (or change amount, or stepping rate) varies according to the content of the image data.

In one embodiment, the stepping rate varies according to the content change-rate of the image data.

### BRIEF DESCRIPTION OF THE DRAWINGS

FIG. 1 shows a conventional technique used to smoothly change a backlight luminance;

FIG. 2 is a schematic outlining an adaptive stepping-rate control system and method for dynamic backlight control (DBLC) according to one embodiment of the present invention;

FIG. 3 is an exemplary illustration of a (slow content change) sequence of image frames and associated backlight luminance during a stepping-control period; and

FIG. 4 is another example illustrating a (fast content change) sequence of image frames and associated backlight luminance during the stepping-control period.

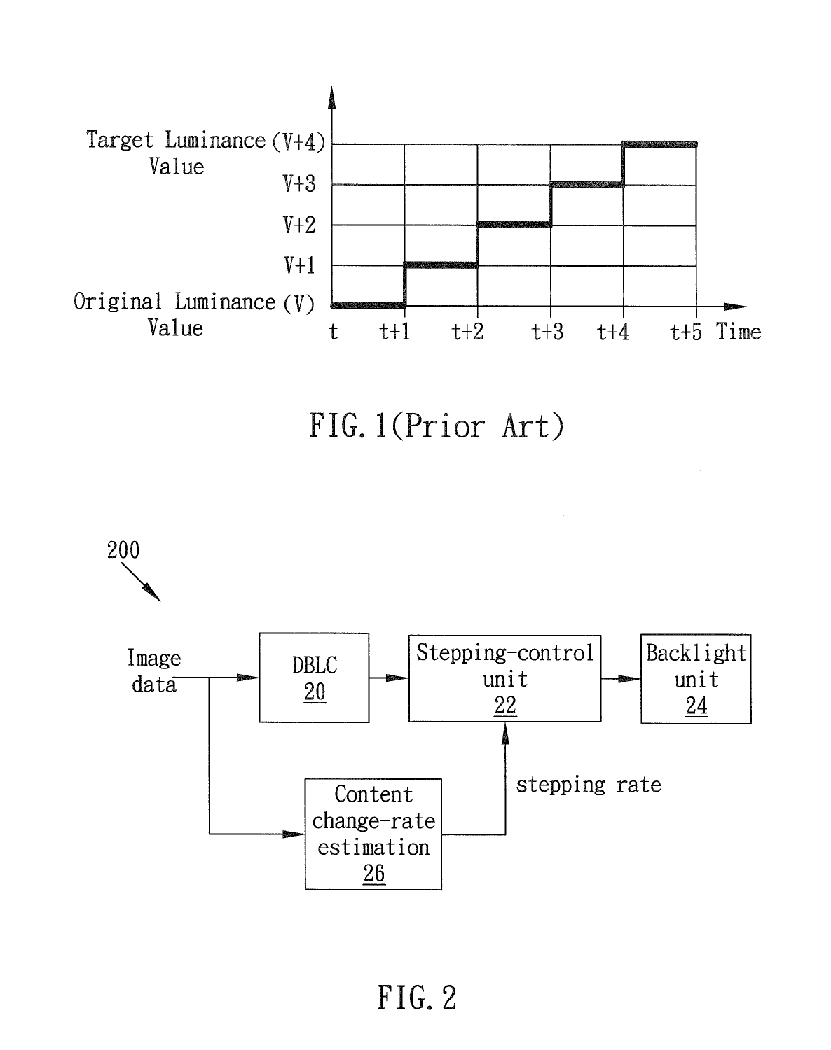

### DETAILED DESCRIPTION OF THE INVENTION

FIG. 2 illustrates in schematic form an adaptive stepping-rate (aka, dimming-rate) control system 200 and method for dynamic backlight control (DBLC) according to one embodiment of the present invention. In the embodiment, a dynamic backlight control (DBLC) device 20 dynamically adjusts (overall or respective portions of) the backlight luminance in accordance with image data distribution. For example, a backlight unit (BLU) 24 is controlled to output high luminance when the image is bright and to be dimmed to a lower luminance when the image is dark. In other embodiments, the dynamic backlight control (DBLC) device 20 may additionally or alternatively dynamically adjust (overall or respective portions of) the backlight luminance in accordance with ambient light.

The output of the dynamic backlight control (DBLC) device 20 provides, via a stepping-control unit 22, control signals to the backlight unit (BLU) 24. In an exemplary embodiment, the dynamic backlight control (DBLC) device 20 provides, via the stepping-control unit 22, pulse-width modulation (PWM) signals having a duty proportional to the backlight luminance. The stepping-control unit 22 (embodied, for example, as a circuit) is utilized to adjust the output of the dynamic backlight control (DBLC) device 20, such that the backlight luminance generated by the backlight unit (BLU) 24 may change in a smooth manner. In this embodiment, the backlight unit (BLU) 24 controllably changes its luminance from an original luminance value to a target luminance value in a stepwise manner, rather than sharply or directly changing from the original value to the target value, thereby improving the annoying flicker effect.

In the embodiment, the amount of change (or the change amount, or the step) of backlight luminance per unit time varies according to the content of the image data. In other words, the stepping rate (or dimming rate) is generally not a constant. According to a feature of the present invention, the variable stepping rate to the stepping-control unit 22 is determined by a content change-rate estimation device 26, which receives and analyzes image data to estimate the content change-rate of the image data.

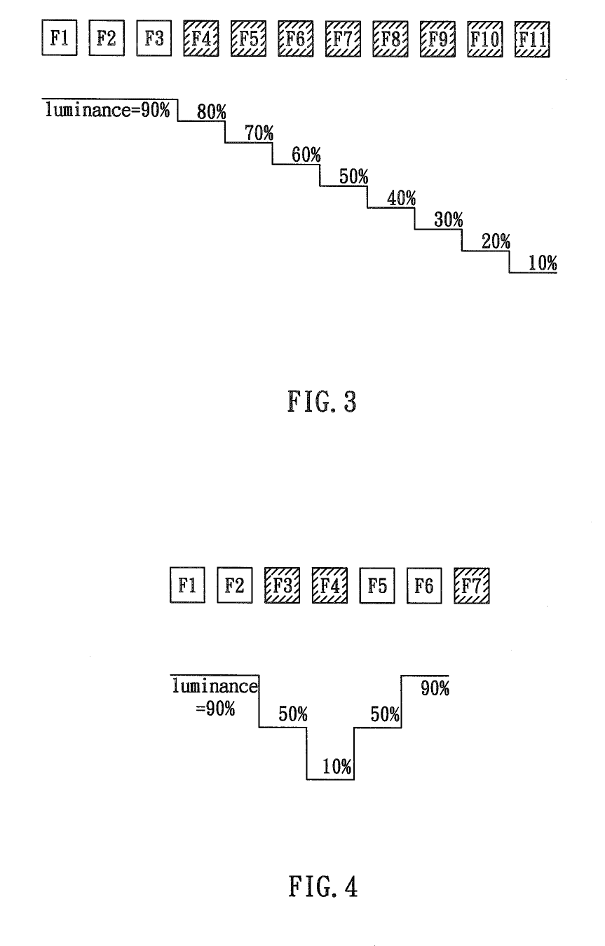

FIG. 3 shows an exemplary implementation of the invention in which a (slow content change) sequence of image frames and associated backlight luminance occur during the stepping-control period. As shown in the figure, bright image frames F1-F3, respectively, have an average brightness corresponding to 90% backlight luminance. Subsequently, dark image frames F4-F11, respectively, have an average brightness corresponding to 10% backlight luminance. According to the figure, as the number of the dark image frames F4-F11 with change content is substantively large (compared to a predetermined number), it is therefore determined (by the content change-rate estimation device 26) that the sequence of image frames F1-F11 possesses a slow content change. Accordingly, the content change-rate estimation device 26, for example, provides a small stepping rate of (minus) 10% luminance per unit time to the backlight unit (BLU) 24. In other words, the backlight unit (BLU) 24 accordingly decreases 10% luminance per unit time.

FIG. 4 shows another example in which a (fast content change) sequence of image frames and associated backlight luminance occur during the stepping-control period. As shown in the figure, bright image frames F1-F2, respectively, have an average brightness corresponding to 90% backlight luminance. Subsequently, dark image frames F3-F4, respectively, have an average brightness corresponding to 10% backlight luminance. Further, bright image frames F5-F6, respectively, have an average brightness corresponding to 90% backlight luminance. Finally, a dark image frame F7 follows F6. According to the figure, as the number of the dark image frames F3-F4 with change content is substantively small (compared to a predetermined number), it is therefore determined (by the content change-rate estimation device 26) that the sequence of image frames up to F4 possesses a fast content change. Accordingly, the content change-rate estimation device 26, for example, provides a large stepping rate of (minus) 40% luminance per unit time to the backlight unit (BLU) 24. In other words, the backlight unit (BLU) 24 accordingly decreases 40% luminance per unit time. Afterwards, a change in the image again corresponds to a change from the dark image frames F3-F4 to the bright image frames F5-F6. As the number of the bright image frames F5-F6 with change content is substantively small (compared to a predetermined number), it is therefore determined (by the content change-rate estimation device 26) that the sequence of image frames from F5 possesses a fast content change.

Accordingly, the content change-rate estimation device 26, for example, provides a large stepping rate of (plus) 40% luminance per unit time to the backlight unit (BLU) 24. In other words, the backlight unit (BLU) 24 accordingly increases 40% luminance per unit time.

According to the embodiment described above, stepping control for the backlight unit (BLU) 24 adaptively varies according to the content change-rate of the image frames. As a result, the image frames can be displayed smoothly without flicker, and the backlight unit (BLU) 24 can respond fast enough to the target luminance, thereby obtaining satisfactory dynamic contrast.

Although specific embodiments have been illustrated and described, it will be appreciated by those skilled in the art that various modifications may be made without departing from the scope of the present invention, which is intended to be limited solely by the appended claims.

What is claimed is:

1. An adaptive stepping-control system for dynamic backlight control, comprising:
a dynamic backlight control device for dynamically adjusting backlight luminance; and
a stepping-control unit for adjusting output of the dynamic backlight control device, such that backlight luminance generated from a backlight unit changes smoothly;
wherein an amount of change of the backlight luminance per unit time varies according to image data content.

2. The system of claim 1, wherein the dynamic backlight control device dynamically adjusts the backlight luminance in accordance with one or more of image data distribution and ambient light.

3. The system of claim 1, wherein the backlight unit changes luminance in a stepwise manner under control of the stepping-control unit.

4. The system of claim 1, wherein the stepping-control unit generates pulse-width modulation (PWM) signals each having a duty proportional to the backlight luminance.

5. The system of claim 1, further comprising a content change-rate estimation device, which receives and analyzes the content of the image data in order to estimate content change-rate of the image data.

6. The system of claim 5, wherein the content is an average brightness of an image frame.

7. An adaptive stepping-control method for dynamic backlight control, comprising:
generating backlight control signals in accordance with image data; and
adjusting the backlight control signals, such that backlight luminance generated from a backlight unit changes smoothly;
wherein an amount of change of the backlight luminance per unit time varies according to image data content.

8. The method of claim 7, wherein the backlight control signals are generated in accordance with one or more of image data distribution and ambient light.

9. The method of claim 7, wherein the backlight unit changes luminance in a stepwise manner under control of the adjusted backlight control signals.

10. The method of claim 7, wherein the adjusted backlight control signals are pulse-width modulation (PWM) signals each having a duty proportional to the backlight luminance.

11. The method of claim 7, further comprising a step of receiving and analyzing the content of the image data in order to estimate content change-rate of the image data.

12. The method of claim 11, wherein the content is an average brightness of an image frame.
